(19) United States
(12) Patent Application Publication
(10) Pub. No.: US 2026/0037347 A1
(43) Pub. Date: Feb. 5, 2026

(54) INTER-CORE COMMUNICATION SYSTEM, METHOD AND DEVICE FOR MULTI-CORE PROCESSOR, AND STORAGE MEDIUM

(71) Applicant: SANECHIPS TECHNOLOGY CO., LTD., Shenzhen (CN)

(72) Inventor: Mancheng XU, Shenzhen (CN)

(21) Appl. No.: 19/109,848

(22) PCT Filed: Apr. 17, 2023
(86) PCT No.: PCT/CN2023/088744

§ 371 Date: Mar. 7, 2025

(30) Foreign Application Priority Data
Oct. 11, 2022 (CN) 202211263547.1

(51) Int. Cl. G06F 9/54; G06F 13/16

(52) U.S. Cl. CPC G06F 9/546; G06F 13/16; G06F 2213/16

(57) ABSTRACT

Disclosed are an inter-core communication system, method and device for a multi-core processor and a storage medium. The system includes: an inter-core communication device connected to multiple systems. The multiple systems include a first system and a second system. The inter-core communication device includes: a memory management module configured to receive a descriptor application instruction sent by the first system and determine a descriptor pointer corresponding to the descriptor application instruction, the first system stores data to be transmitted in the memory corresponding to the descriptor pointer; a queue management module configured to enqueue the descriptor pointer to the specified queue after receiving an enqueue application sent by the first system; an interrupt module configured to dequeue a descriptor in the specified queue through an interrupt service program of the second system after the number of times of enqueues corresponding to the specified queue reaches a preset threshold.

### CROSS-REFERENCE TO RELATED APPLICATIONS

This application is a U.S. National Phase application of International Application No. PCT/CN2023/088744, filed on Apr. 17, 2023, which claims priority to Chinese Patent Application No. 202211263547.1, filed on Oct. 11, 2022.

### TECHNICAL FIELD

The present application relates to the technical field of processors, and in particular to an inter-core communication system, an inter-core communication method and an inter-core communication device for a multi-core processor, and a storage medium.

### BACKGROUND

At present, the inter-core communication technology of multi-core processors is generally based on the mailbox module to achieve interaction, but this mailbox module mainly provides an interrupt-based communication service to the central processing unit (CPU), and the CPU participates in the interaction. That is, this inter-core communication technology requires the CPU to participate in operations such as message copying, queue space maintenance, and message channel access arbitration, which increases thread occupancy and reduces performance of CPU.

### SUMMARY

The main purpose of the present application is to provide an inter-core communication system, an inter-core communication method and an inter-core communication device of a multi-core processor and a storage medium, aiming to solve the technical problem of how to reduce central processing unit (CPU) occupancy during inter-core communication and improve performance of CPU.

To achieve the above purpose, the present application provides an inter-core communication method system for a multi-core processor, including an inter-core communication device connected to a plurality of systems, and the plurality of systems include a first system and a second system. The inter-core communication device includes:
a memory management module configured to receive a descriptor application instruction sent by the first system and determine a descriptor pointer corresponding to the descriptor application instruction, the first system is configured to store data to be transmitted in a memory corresponding to the descriptor pointer;
a queue management module configured to enqueue the descriptor pointer to a specified queue after receiving an enqueue application sent by the first system; and
an interrupt module configured to dequeue the descriptor pointer in the specified queue through an interrupt service program of the second system after the number of times of enqueues corresponding to the specified queue reaches a preset threshold, the second system is configured to read data to be transmitted in a memory corresponding to the dequeued descriptor pointer.

In addition, to achieve the above purpose, the present application further provides an inter-core communication method for a multi-core processor, applied to the inter-core communication system for the multi-core processor as described above, including:
receiving a descriptor application instruction sent by a first system, and determine a descriptor pointer corresponding to the descriptor application instruction, the first system stores data to be transmitted into memory corresponding to the descriptor pointer;
after receiving an enqueue application sent by the first system, enqueuing the descriptor pointer into a specified queue; and
after the number of times of enqueues corresponding to the specified queue reaches a preset threshold, dequeuing, via an interrupt service program of a second system, a descriptor pointer in the specified queue, the second system reads data to be transmitted in a memory corresponding to the dequeued descriptor pointer.

In addition, to achieve the above purpose, the present application further provides an inter-core communication device for a multi-core processor, including: a memory, a processor and an inter-core communication program for the multi-core processor stored on the memory and executable on the processor. When the inter-core communication program for the multi-core processor is executed by the processor, the inter-core communication method for the multi-core processor as described above is implemented.

In addition, to achieve the above purpose, the present application further provides a storage medium, including a computer-readable storage medium. An inter-core communication program for the multi-core processor is stored on the computer-readable storage medium. When the inter-core communication program for the multi-core processor is executed by the processor, the inter-core communication method for the multi-core processor as described above is implemented.

The present application provides an inter-core communication device connected to multiple systems, the management of message data and message space during inter-core communication between various systems is handed over to the memory management module and the queue management module for processing, and the application of descriptor pointers is completed by the memory management module. The queue management corresponding to the descriptor pointer is completed by the queue management module, without the need for the system's own internal CPU to process it. This reduces the CPU occupancy during inter-core communication and improves the CPU performance while ensuring normal data transmission between various systems.

### BRIEF DESCRIPTION OF THE DRAWINGS

FIG. 1 is a schematic structural diagram of a terminal/device of a hardware operating environment involved in an embodiment of the present application.

FIG. 2 is a schematic diagram of an overall framework of an inter-core communication system for a multi-core processor according to the present application.

FIG. 3 is a schematic diagram of an internal structure of an inter-core communication device in the inter-core communication system for the multi-core processor according to the present application.

FIG. 4 is a schematic diagram of an internal structure of a memory management module in the inter-core communication system for the multi-core processor according to the present application.

FIG. 5 is a schematic diagram of an internal structure of a queue management module in the inter-core communication system for the multi-core processor according to the present application.

FIG. 6 is a flow chart of inter-core communication in the inter-core communication system for the multi-core processor according to the present application.

FIG. 7 is a flow chart of multiple systems simultaneously accessing the inter-core communication device in the inter-core communication system for the multi-core processor according to the present application.

FIG. 8 is a schematic diagram of queue alarm interruption in the inter-core communication system for the multi-core processor according to the present application.

FIG. 9 is a flow chart of an inter-core communication method for the multi-core processor according to the present application.

The purpose, features and advantages of the present application will be further described in conjunction with the embodiments and with reference to the accompanying drawings.

### DETAILED DESCRIPTION OF THE EMBODIMENTS

It should be understood that the specific embodiments described herein are only used to explain the present application and are not used to limit the present application.

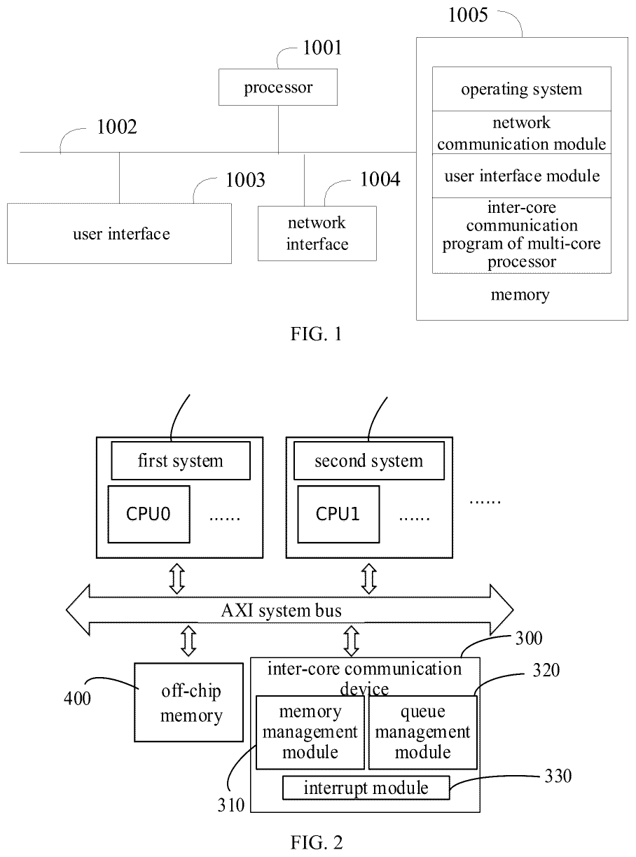

As shown in FIG. 1, FIG. 1 is a schematic structural diagram of a terminal of a hardware operating environment involved in the embodiment of the present application.

The terminal in the embodiment of the present application is an inter-core communication device for a multi-core processor.

As shown in FIG. 1, the terminal can include: a processor 1001 such as a CPU, a network interface 1004, a user interface 1003, a memory 1005, and a communication bus 1002. The communication bus 1002 is used to realize the connection and communication between these components. The user interface 1003 can include a display and an input unit such as a keyboard. The user interface 1003 can also include a standard wired interface and a wireless interface. The network interface 1004 can include a standard wired interface and a wireless interface (such as a WI-FI interface). The memory 1005 can be a high-speed memory or a stable memory (non-volatile memory), such as a disk memory. The memory 1005 can also be a storage device independent of the aforementioned processor 1001.

In some embodiments, the terminal can also include a camera, a radio frequency (RF) circuit, a sensor, an audio circuit, a WiFi module, and the like. The sensors include light sensors, motion sensors, and other sensors. The light sensor can include an ambient light sensor and a proximity sensor. The ambient light sensor can adjust the brightness of the display according to the brightness of the ambient light, and the proximity sensor can turn off the display and/or backlight when the terminal device moves to the ear. The terminal device can also be configured with other sensors such as a gyroscope, a barometer, a hygrometer, a thermometer, an infrared sensor, which will not be repeated here.

Those skilled in the art will appreciate that the terminal structure shown in FIG. 1 does not constitute a limitation on the terminal, and may include more or fewer components than shown, or combinations of certain components, or differently arranged components.

As shown in FIG. 1, the memory 1005 as a computer storage medium can include an operating system, a network communication module, a user interface module, and an inter-core communication program of a multi-core processor.

In the terminal shown in FIG. 1, the network interface 1004 is mainly used to connect to a backend server and perform data communication with the backend server. The user interface 1003 is mainly used to connect to a client (user end) and perform data communication with the client. The processor 1001 can be used to call an inter-core communication program for the multi-core processor stored in the memory 1005 and perform the following operations.

Receiving a descriptor application instruction sent by a first system, determining the descriptor pointer corresponding to the descriptor application instruction. The first system stores data to be transmitted in a memory corresponding to the descriptor pointer.

After receiving an enqueue application sent by the first system, enqueuing the descriptor pointer to the specified queue.

After the number of times of enqueues corresponding to the specified queue reaches a preset threshold, dequeuing, via an interrupt service program of a second system, the descriptor pointer in the specified queue. The second system reads the data to be transmitted in the memory corresponding to the dequeued descriptor pointer.

Referring to FIG. 2, the present application provides an inter-core communication system for a multi-core processor. In a first embodiment of the inter-core communication system for the multi-core processor, the inter-core communication system for the multi-core processor includes an inter-core communication device 300 connected to multiple systems, and the multiple systems include a first system 100 and a second system 200. The inter-core communication device 300 includes a memory management module 310, a queue management module 320 and an interrupt module 330.

The memory management module 310 is configured to receive the descriptor application instruction sent by the first system, and determine the descriptor pointer corresponding to the descriptor application instruction. The first system stores the data to be transmitted in the memory corresponding to the descriptor pointer.

The queue management module 320 is configured to enqueue the descriptor pointer to the specified queue after receiving the enqueue application sent by the first system.

The interrupt module 330 is configured to dequeue the descriptor pointer in the specified queue through the interrupt service program of the second system after the number of times of enqueuing corresponding to the specified queue reaches the preset threshold. The second system reads the data to be transmitted in the memory corresponding to the dequeued descriptor pointer.

Due to the current inter-core communication mode, the CPU needs to participate in operations such as copying messages, maintaining queue space, and arbitrating access to message channels, which increases thread occupancy and reduces performance of CPU. Therefore, in this embodiment, when performing inter-core communication, it can be implemented based on a mechanism of shared memory plus interrupt service, and the inter-core communication device 300 mainly includes a memory management module 310 and a queue management module 320. Both the memory management module 310 and the queue management module 320 are provided with an on-chip buffer pool. The off-chip double data rate (DDR) is actively accessed through Advanced extensible Interface (AXI, bus protocol) bus interface to read and write the descriptor pointer of the memory, and the CPU configures the memory management module 310 and the queue management module 320 through the AXI bus interface. In addition, the memory management module 310 can manage the descriptor pointer in a first input first output (FIFO) manner, and provide the CPU with an application and release interface for the descriptor pointer. In addition, the queue management module 320 manages the descriptor pointer in a FIFO queue manner, and provides the CPU with an entry and exit interface for the descriptor pointer. Therefore, in this embodiment, a communicating CPU can obtain the descriptor pointer through the memory management module 310 and enqueue the descriptor pointer to the queue management module 320. Another communicating CPU can dequeue from the queue management module 320 to obtain the descriptor pointer, to read the communication data according to the descriptor pointer.

In this embodiment, before performing inter-core communication of the multi-core processor, it is necessary to configure the inter-core communication system for the multi-core processor, which can include two parts: module initialization and interrupt registration. In the module initialization, if two systems are set in the inter-core communication system for the multi-core processor, namely the first system 100 and the second system 200, and the first system 100 has one core, CPU0 while the second system 200 has one core, CPU1. Therefore, each module can be initialized and configured by CPU0 or CPU1. For example, if each module is initialized and configured by CPU0, CPU0 can access the control register of the memory management module 310 through the AXI_Slave interface, configure the number of different types of buffer blocks into the register, and thereby calculate the DDR memory size occupied by the buffer block. CPU0 allocates the memory segment and configures the start address and end address into the control register. CPU0 accesses the control register of the queue management module 320 through the AXI_Slave interface, configures the number of queue elements of each queue into the register of this module, and then calculates the DDR memory size that the queue management module 320 needs to manage according to the product of the number of queues, the number of queue elements in each queue, and the size of the queue elements. After allocating the memory segment, CPU0 configures the start address and the end address of the memory into the module control register. After CPU0 writes the module enable into the control register, the initialization configuration of the memory management module 310 and the queue management module 320 is completed.

In the interrupt registration part, the memory application interface and the memory release interface of the memory management module 310 both have abnormal interrupt sources. When CPU0 initializes the memory management module 310 through the AXI_Slave interface, the descriptor application and release abnormal interrupt sources are enabled and configured (that is, the configuration function can be performed). Each queue of the queue management module 320 has an enqueue application interrupt source, a dequeue application abnormal interrupt source and a queue alarm interrupt source. When CPU0 initializes the queue management module 320 through the AXI Slave interface, in addition to enabling and configuring the abnormal interrupt source and the alarm interrupt source, the alarm depth of the queue alarm interrupt is also configured. The queue alarm interruption working mechanism during the queuing process is shown in FIG. 2. When the alarm depth n of queue No. 0 configured by CPU0 is 1, CPU0 will trigger an alarm interruption after entering queue No. 0 once. This interruption can be called a queue non-empty interruption. When the alarm depth n of queue No. 0 configured by CPU0 is greater than 1, CPU0 enqueues the queue No. 0 n times before triggering the alarm interruption. This interruption can be called a queue full interruption. After the queue generates an interruption, the interruption status can be cleared by configuring the relevant registers. In this embodiment, CPU1 registers the alarm interruption of the specified queue. When the number of times CPU0 enqueues into the queue reaches the alarm depth, the alarm interruption is triggered and the interrupt service program of CPU1 is entered. The triggering of each interrupt service process in this embodiment is realized by the interrupt module 330.

In this embodiment, after completing the module initialization configuration and interrupt registration of each module, the subsequent inter-core communication operation can be performed. At this time, the descriptor enqueue operation can be performed. That is, CPU0 can access the memory management module 310 according to the data size of the data to be transmitted by the first system 100, so as to send a descriptor request instruction to the memory management module 310. After receiving the descriptor request instruction, the memory management module 310 determines whether the current memory is sufficient. If the memory is sufficient, the memory management module 310 determines the descriptor pointer corresponding to the descriptor request instruction, and feeds back the information of the successful application of the descriptor pointer to CPU0 in the first system 100. CPU0 stores the data to be transmitted in the memory pointed to by the descriptor pointer. However, when the memory management module 310 determines that the current memory is insufficient or there are other abnormalities, it will determine that the application for the descriptor pointer has failed, and when the application has failed, and after registering the descriptor application abnormal interrupt in advance, it will enter the application abnormal interrupt service program of CPU0 to perform interrupt service processing, that is, at this time, the interrupt module 330 will be triggered.

After the first system 100 applies for the descriptor pointer, it will perform a descriptor enqueue operation, which may be that CPU0 accesses the descriptor enqueue register of the queue management module 320 to enqueue the descriptor pointer to the specified queue of the queue management module 320. For example, the first system 100 sends an enqueue application to the queue management module 320. Similarly, if the enqueue exception interrupt is registered, the enqueue exception interrupt service program of CPU0 will be entered when the enqueue fails.

When the descriptor pointer is enqueued to the specified queue, the interrupt module 330 will detect the queue depth of the specified queue, and trigger the alarm interrupt of the specified queue after the number of enqueues reaches a preset threshold (any threshold set by the user in advance). Since CPU1 in the second system 200 registers the alarm interrupt of this queue, it will enter the interrupt service program of CPU1. Then, the descriptor is dequeued. In the interrupt service program, CPU1 obtains the queue depth of the specified queue, that is, the number of data transmissions by CPU0, by accessing the queue management module 320, and dequeues the descriptor pointer according to the queue depth, that is, all descriptor pointers in the specified queue can be dequeued in order. Finally, it enters the descriptor release stage. At this time, after CPU1 obtains the descriptor pointer, it can read the data written by CPU0 from the memory pointed to by the descriptor pointer. After CPU1 has used the memory space, it writes the descriptor pointer to the descriptor release register and returns the descriptor pointer to the memory management module 310, thus completing the inter-core data interaction process between CPU0 and CPU1 in the multi-core heterogeneous platform, that is, completing the inter-core data interaction between the first system 100 and the second system 200.

For example, as shown in FIG. 6, the process includes first performing module initialization configuration. This involves configuring the memory management module and the queue management module via CPU0 in the first system 100, registering and enabling interruption via CPU0, registering and enabling interruption via CPU1, and performing the memory application via CPU0. The memory management module buffers the application operation. If the memory management module does not buffer the application operation, an abnormal interruption is determined. If the memory management module buffers the application operation, CPU0 obtains a memory descriptor pointer, CPU0 writes data to the memory, and CPU0 performs an enqueue application. Enqueue operation is performed through the queue management module. If the queue management module does not perform the enqueue operation, an abnormal interruption occurs. If the queue management module performs the enqueue operation, it is determined that whether the queue depth reaches the alarm depth. If the queue depth does not reach the alarm depth, the queue depth is increased by 1. If the queue depth reaches the alarm depth, the queue triggers an alarm interruption and CPU1 performs the dequeue application. Dequeue operation is performed through the queue management module. If the queue management module does not perform the dequeue operation, an abnormal interruption occurs. If the queue management module performs the dequeue operation, CPU1 obtains the memory descriptor pointer and performs memory release. The memory management module buffers the release operation. If the memory management module does not buffer the release operation, an abnormal interruption occurs. If the memory management module buffers the release operation, the next inter-core data communication is performed.

In this embodiment, the management of message data and message space during inter-core communication between various systems is handed over to the memory management module and the queue management module for processing, and the application of descriptor pointers is completed by the memory management module. The queue management corresponding to the descriptor pointer is completed by the queue management module, without the need for the system's own internal CPU to process it. This reduces the CPU occupancy during inter-core communication and improves the CPU performance while ensuring normal data transmission between various systems.

Based on the above first embodiment, a second embodiment of the inter-core communication system for the multi-core processor according to the present application is proposed. Referring to FIG. 4, in the inter-core communication system for the multi-core processor, the memory management module 310 includes a first bus interface 311, a first register 312, a buffer 313 and an on-chip memory 314. The memory management module 310 is connected to each of the systems and the off-chip memory 400 through the first bus interface 311.

The first register 312 is configured to determine the descriptor pointer corresponding to the descriptor application instruction after receiving the descriptor pointer application instruction sent by the first system 100, and store the descriptor pointer in the on-chip memory 314.

The buffer 313 is configured to read the descriptor pointer from the off-chip memory 400 into the on-chip memory 314 after the number of descriptor pointers in the on-chip memory 314 is less than the preset number, and read the descriptor pointer from the on-chip memory 314 into the off-chip memory 400 after the number of descriptor pointers in the on-chip memory 314 is greater than the preset number.

In this embodiment, the first bus interface 311 in the memory management module 310 can include two kinds of first bus interfaces 311 such as two kinds of AXI bus interfaces. The buffer 313 can be a FIFO buffer, and an on-chip memory structure of the on-chip memory 314. The two kinds of AXI bus interfaces can include an AXI Slave interface and an AXI Master interface. The AXI Slave interface is used for CPU0 to read and write registers of the memory management module 310, and the AXI Master interface is used for the memory management module 310 to actively access the off-chip memory 400.

Moreover, in this embodiment, the memory management module 310 manages the descriptor pointers in a secondary storage manner, that is, a part of the descriptor pointers are stored in the on-chip memory 314, and the other part is stored in the off-chip memory 400. The FIFO buffer is used to control the number of descriptor pointers in the on-chip memory. When the number of descriptor pointers in the on-chip RAM is less than the preset number (any number set by the user in advance), the FIFO controller will access the off-chip memory 400 through the AXI_Master interface, and read part of the descriptor pointers from the off-chip memory 400 into the on-chip memory 314. On the contrary, when the number of descriptor pointers in the on-chip memory 314 exceeds the preset number, the FIFO controller will write the excess descriptor pointers to the off-chip memory 400.

In this embodiment, by setting the first bus interface 311, the first register 312, the buffer 313 and the on-chip memory 314 in the memory management module 314, the first system 100 and the second system 200 can apply for the descriptor pointer through the first register 312 and store the descriptor pointer through the buffer 313 when performing inter-core communication, so that the first system can store the data to be transmitted in the memory corresponding to the descriptor pointer, thereby ensuring the effective inter-core communication.

In an embodiment, referring to FIG. 4, the first register 312 includes a control register 3121, a descriptor application register 3122, a descriptor release register 3123 and a statistical register 3124.

The control register 3121 is configured to determine the descriptor pointer corresponding to the descriptor application instruction after receiving the descriptor pointer application instruction sent by the first system 100, and store the descriptor pointer to the on-chip memory 314.

The descriptor application register 3122 is configured to provide an application interface for the descriptor pointer to the first system 100.

The descriptor release register 3123 is configured to provide a release interface for the descriptor pointer to the first system 100.

The statistical register 3124 is configured to count the number of times of operations on the descriptor pointer.

In this embodiment, the control register 3121 is used for the CPU to configure the memory management module 310. The descriptor application register 3122 and the descriptor release register 3123 are configured to provide the CPU with the application interface and release interface for the memory descriptor. The statistical register 3124 is configured to count the number of descriptor operations.

In this embodiment, the first register 312 is divided into multiple registers according to different functions, including the control register 3121, the descriptor application register 3122, the descriptor release register 3123 and the statistical register 3124, so that the first system 100 can sequentially apply for the descriptor pointer in the memory management module 310, so as to perform subsequent inter-core communication operations according to the descriptor pointer.

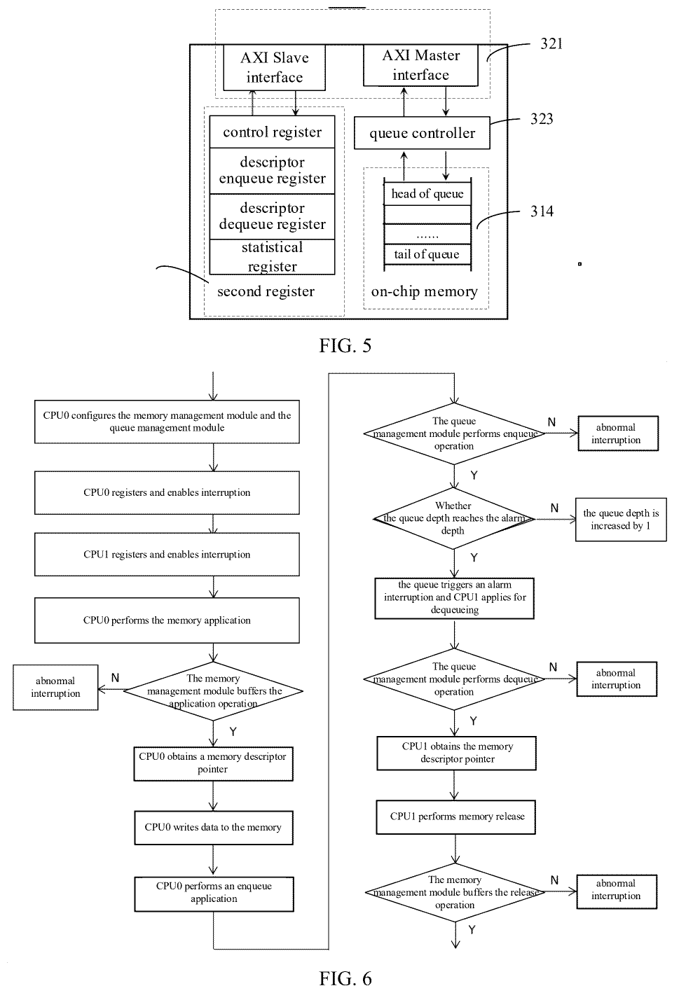

In an embodiment, referring to FIG. 5, the queue management module 320 includes a second bus interface 321, a second register 322, a queue controller 323 and an on-chip memory 314. The queue management module 320 is connected to each of the systems and the off-chip memory 400 through the second bus interface 321.

The second register 322 is configured to determine the specified queue corresponding to the descriptor pointer through the queue controller 323 after receiving the queue application sent by the first system 100, and queue the descriptor pointer to the specified queue.

The queue controller 323 is configured to read the descriptor pointer in the off-chip memory 400 after the descriptor pointer in the on-chip memory 314 is less than a preset number.

In this embodiment, as shown in FIG. 5, the queue management module 320 can also include two kinds of second bus interfaces 321, and can be two kinds of AXI bus interfaces. The two kinds of AXI bus interfaces can include an AXI Slave interface and an AXI Master interface. The AXI Slave interface is used for CPU0 to read and write registers of the queue management module 320, and the AXI Master interface is used for the queue management module 320 to actively access the off-chip memory 400. In this embodiment, the structure of the queue management module 320 is similar to that of the memory management module 310. The descriptor pointers in the queue are stored in the on-chip memory 314, and are stored in a head-to-tail manner. The queue controller 323 will maintain the number of descriptor pointers corresponding to each queue in the on-chip memory 314, and perform queue and dequeue operations on the descriptor pointers corresponding to each queue in the on-chip memory 314 in a first-in-first-out manner. When the descriptor pointer of the specified queue in the on-chip memory 314 is less than the preset number (any number set by the user in advance), the descriptor pointer in the off-chip memory 400 will be actively accessed through the AXI Master interface to read the descriptor pointer into the on-chip memory. The descriptor queue and dequeue registers are configured to provide the CPU with the queue and dequeue interface of the memory descriptor, and the statistical register is configured to count the number of queue dequeues and queues. The second register 322 in the queue management module 320 has a similar structure to the first register 312 in the memory management module 310, and also includes a control register, a descriptor enqueue register, a descriptor dequeue register and a statistical register.

When the first system 100 performs a queue operation, the queue operation can be implemented by accessing the second register 322 in the queue management module 320. After receiving the queue application, the second register will first determine the specified queue corresponding to the descriptor pointer. If the specified queue cannot be determined and the queue exception interrupt is registered, the queue exception interrupt service program of CPU0 in the first system 100 will be entered when the queue fails. If the specified queue can be determined, the descriptor pointer is queued to the specified queue.

In this embodiment, the second bus interface 321, the second register 322, the queue controller 323 and the on-chip memory 314 are set in the queue management module 320, so that after the first system 100 applies for the descriptor pointer, it can sequentially store the descriptor pointer in the specified queue, which is convenient for the second system 200 to extract the descriptor pointer from the specified queue, thereby completing the inter-core communication operation.

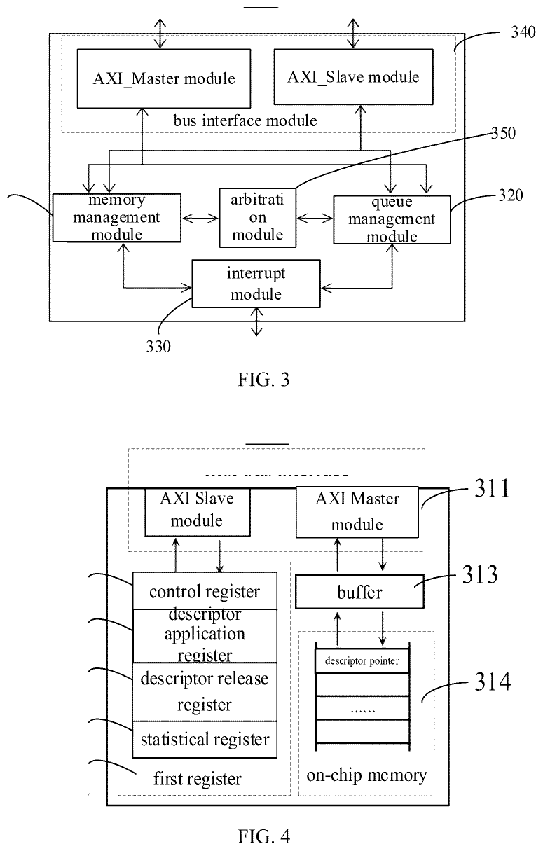

In an embodiment, referring to FIG. 3, the inter-core communication device 300 further includes a bus interface module 340, through which the memory management module 310 and the queue management module 320 are connected to each of the systems.

In this embodiment, the bus interface module 340 can be an AXI Slave module and an AXI Master module. The bus interface module 340 is respectively connected to the AXI Slave interface in the memory management module 310 and the AXI Slave interface in the queue management module 320 through the AXI Slave module, and is respectively connected to the AXI Master interface in the memory management module 310 and the AXI Master interface in the queue management module 320 through the AXI Master module. The AXI Slave module and the AXI Master module are connected to each system through an externally set AXI system bus, thereby realizing the connection between each module and each system in this embodiment.

In this embodiment, a bus interface module 340 is also provided in the inter-core communication device, and a connection between the external system and the inter-core communication device 300 is established through the bus interface module 340, thereby ensuring the normal conduct of subsequent inter-core communication.

In an embodiment, referring to FIG. 3, the inter-core communication device 300 further includes an arbitration module 350 respectively connected to the memory management module 310 and the queue management module 320. The arbitration module 350 is configured to perform access arbitration on the access of each of the systems according to a preset communication order when detecting that multiple systems access the inter-core communication device 300 at the same time, and respond to the access of each of the systems in turn.

In this embodiment, when multiple cores access the memory management module 310 and the queue management module 320 simultaneously, as shown in FIG. 2, CPU0 in the first system 100 and CPU1 in the second system simultaneously apply for descriptors of the same size, that is, simultaneously access the same memory application interface of the memory management module. At this time, the arbitration module 350 responds to the access request of CPU0 first in a serial access manner according to the pre-set settings, and responds to the access request of CPU1 after the memory management module 310 successfully allocates the buffer block descriptor of the corresponding size. In addition, for the situation where multiple cores release descriptors through the same memory release interface and queue elements are queued and dequeued through the same dequeue interface, the workflow of the arbitration module 350 is the same as that of the multi-core memory application described above. For example, as shown in FIG. 3, the arbitration module 350 is connected to the memory management module 310 and the queue management module 320 respectively, the interrupt module 330 is connected to the memory management module 310 and the queue management module 320 respectively, and the memory management module 310 and the queue management module 320 are both connected to the bus interface module 340. The bus interface module 340 includes an AXI Slave module and an AXI Master module.

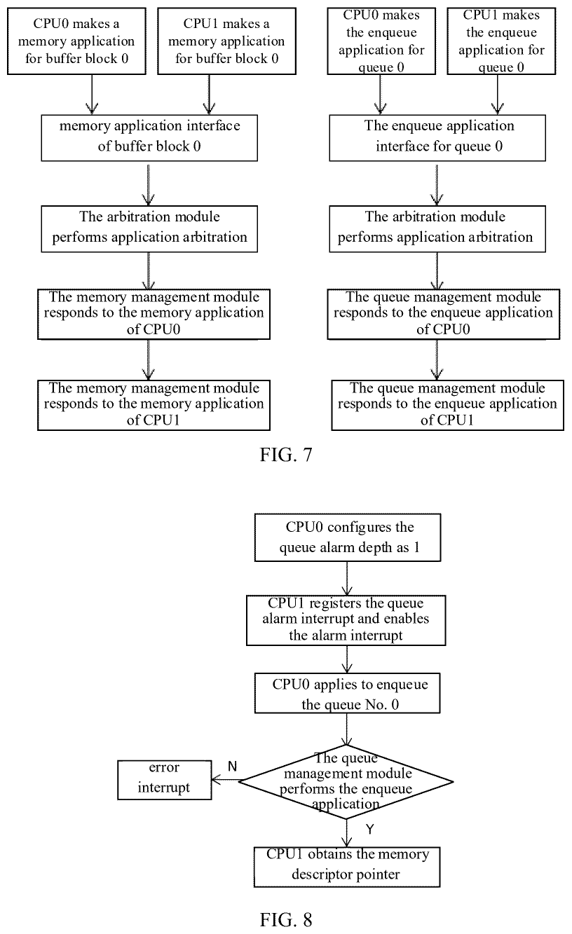

For example, as shown in FIG. 7, if CPU0 makes the memory application for buffer block 0 and CPU1 makes the memory application for buffer block 0, the memory application interface for buffer block 0 is determined first. The application interrupt is performed through the arbitration module. If it is determined that the memory application of CPU0 is made first, the memory management module responds to the memory application of CPU0, and then the memory management module responds to the memory application of CPU1. In the queue management module, if CPU0 makes the enqueue application for queue 0 and CPU1 makes the enqueue application for queue 0, the enqueue application interface for queue 0 is determined first, the application arbitration is performed through the arbitration module, then the queue management module responds to the enqueue application of CPU0, and after the response is completed, the queue management module responds to the enqueue application of CPU1.

In this embodiment, the arbitration module is also provided in the inter-core communication device, so that when multiple systems access the inter-core communication device at the same time, the arbitration module can perform access arbitration according to the communication sequence set in advance, thereby ensuring the effective access of the system to the inter-core communication device.

In an embodiment, the interrupt module 330 is also configured to perform an abnormal interrupt after an abnormality occurs in the memory management module 310, and to perform an abnormal interrupt after an abnormality occurs in the queue management module 320.

In this embodiment, each interrupt in the interrupt module 330 can include an abnormal interrupt when applying for memory or releasing memory in the memory management module 310, an abnormal interrupt when applying for queuing or dequeuing in the queue management module 320, and a queue non-empty alarm interrupt and a queue full alarm interrupt. For example, as shown in FIG. 8, CPU0 configures the queue alarm depth as 1, CPU1 registers the queue alarm interrupt and enables the alarm interrupt. After CPU0 applies to enqueue the queue No. 0, the queue management module performs the enqueue application operation. If the queue management module does not perform the enqueue application operation, the interrupt module triggers an error interrupt, if the queue management module performs the enqueue application operation, CPU1 obtains the memory descriptor pointer.

In this embodiment, the interrupt module 330 can also be configured to perform an abnormal interrupt when an abnormality occurs in the memory management module 310 and the queue management module 320, thereby ensuring the effective inter-core communication and avoiding abnormalities that affect the security of the inter-core communication system for the multi-core processor.

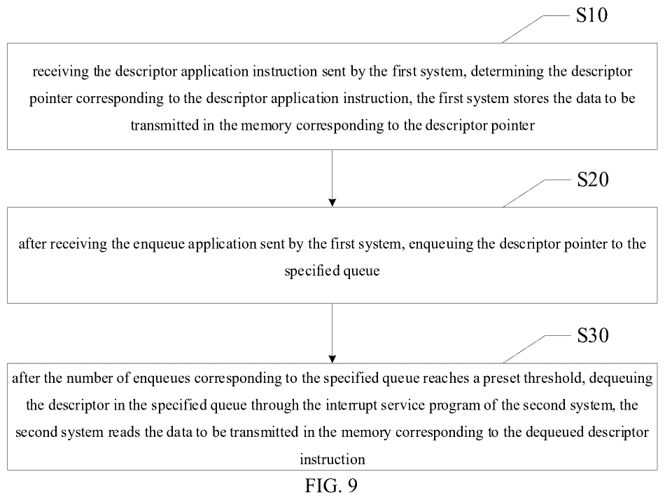

Referring to FIG. 9, the present application provides an inter-core communication method for a multi-core processor. In a third embodiment of the inter-core communication method for the multi-core processor, the inter-core communication method for the multi-core processor is applied to the inter-core communication system for the multi-core processor in any of the above embodiments, including:
Step S10, receiving the descriptor application instruction sent by the first system, determining the descriptor pointer corresponding to the descriptor application instruction, the first system stores the data to be transmitted in the memory corresponding to the descriptor pointer;
Step S20, after receiving the enqueue application sent by the first system, enqueuing the descriptor pointer to the specified queue; and
Step S30, after the number of enqueues corresponding to the specified queue reaches a preset threshold, dequeuing the descriptor in the specified queue through the interrupt service program of the second system, the second system reads the data to be transmitted in the memory corresponding to the dequeued descriptor instruction.

The process of implementing each step of the inter-core communication method for the multi-core processor can refer to the various embodiments of the inter-core communication system for the multi-core processor according to the present application, which will not be repeated here.

In addition, the present application also provides an inter-core communication device for the multi-core processor. The inter-core communication device for the multi-core processor includes: a memory, a processor and an inter-core communication program for the multi-core processor stored on the memory. The processor is used to execute the inter-core communication program for the multi-core processor to implement the steps of each embodiment of the inter-core communication method for the multi-core processor.

The present application also provides a storage medium, which can be a computer-readable storage medium. One or more programs are stored in the computer-readable storage medium, and the one or more programs can also be executed by one or more processors to implement the steps of each embodiment of inter-core communication method for the multi-core processor described above.

The specific implementation of the computer-readable storage medium of the present application is basically the same as the embodiments of the inter-core communication method for the multi-core processor described above, and will not be repeated here.

It should be noted that, as used herein, the terms “include”, “comprise” or any other variation thereof are intended to cover a non-exclusive inclusion, such that a process, method, article or system that includes a list of elements not only includes those elements, but also includes other elements not expressly listed or that are inherent to the process, method, article or system. Without further limitation, an element defined by the statement “include a . . . ” does not exclude the presence of other identical elements in the process, method, article, or system that includes that element.

The above serial numbers of the embodiments of the present application are only for description and do not represent the advantages or disadvantages of the embodiments.

Through the description of the above embodiments, those skilled in the art can clearly understand that the above embodiment methods can be implemented by means of software plus the necessary general hardware platform, of course, by hardware. But in many cases the former is a better implementation. Based on this understanding, the technical solution of the present application can be embodied in the form of a software product in essence or the part that contributes to the existing technology. The computer software product is stored in a storage medium (such as ROM/memory, magnetic disk, optical disk) as mentioned above, and includes several instructions to cause a terminal device (which can be a mobile phone, computer, server, air conditioner, or network equipment, etc.) to execute the method described in each embodiment of the present application.

The above are only some embodiments of the present application, and are not intended to limit the scope of the present application. Any equivalent structural or equivalent process transformation made using the contents of the description and drawings of the present application, or directly or indirectly applied in other related technical fields, is included in the scope of the present application.

1. An inter-core communication system for a multi-core processor, comprising:
an inter-core communication device connected to a plurality of systems, wherein the plurality of systems comprise a first system and a second system, and the inter-core communication device comprises:
a memory management module configured to receive a descriptor application instruction sent by the first system and determine a descriptor pointer corresponding to the descriptor application instruction, wherein the first system is configured to store data to be transmitted in a memory corresponding to the descriptor pointer;
a queue management module configured to enqueue the descriptor pointer to a specified queue after receiving an enqueue application sent by the first system; and
an interrupt module configured to dequeue the descriptor pointer in the specified queue through an interrupt service program of the second system after the number of times of enqueues corresponding to the specified queue reaches a preset threshold, wherein the second system is configured to read data to be transmitted in a memory corresponding to the dequeued descriptor pointer.

2. The inter-core communication system for the multi-core processor according to claim 1, wherein the memory management module comprises a first bus interface, a first register, a buffer and an on-chip memory, and the memory management module is connected to each of the systems through the first bus interface, wherein:
the first register is configured to determine the descriptor pointer corresponding to the descriptor application instruction after receiving the descriptor pointer application instruction sent by the first system, and store the descriptor pointer into the on-chip memory.

3. The inter-core communication system for the multi-core processor according to claim 2, wherein the first register comprises:
a control register configured to determine the descriptor pointer corresponding to the descriptor application instruction after receiving the descriptor pointer application instruction sent by the first system, and store the descriptor pointer into the on-chip memory;
a descriptor application register configured to provide an application interface for a descriptor pointer to the first system;
a descriptor release register configured to provide a release interface of a descriptor pointer to the first system; and
a statistics register configured to count the number of times of operations on the descriptor pointer.

4. The inter-core communication system for the multi-core processor according to claim 1, wherein the queue management module comprises a second bus interface, a second register, a queue controller and an on-chip memory, and the queue management module is connected to each of the systems and an off-chip memory through the second bus interface, wherein:
the second register is configured to determine the specified queue corresponding to the descriptor pointer through the queue controller after receiving the enqueue application sent by the first system, and enqueue the descriptor pointer into the specified queue.

5. The inter-core communication system for the multi-core processor according to claim 1, wherein the inter-core communication device further comprises a bus interface module, and the memory management module and the queue management module are connected to each of the systems through the bus interface module.

6. The inter-core communication system for the multi-core processor according to claim 1, wherein the inter-core communication device further comprises an arbitration module connected to the memory management module and the queue management module, and the arbitration module is configured to perform access arbitration on access of each system according to a preset communication sequence when multiple systems are detected to access the inter-core communication device simultaneously, and respond to the access of each system in turn.

7. The inter-core communication system for the multi-core processor according to claim 1, wherein the interrupt module is further configured to perform an exception interrupt after an exception occurs in the memory management module, and perform an exception interrupt after an exception occurs in the queue management module.

8. An inter-core communication method for a multi-core processor, applied to the inter-core communication system for the multi-core processor, wherein the inter-core communication system for the multi-core processor comprises an inter-core communication device connected to a plurality of systems, the plurality of systems comprises a first system and a second system, and the inter-core communication device comprises a memory management module, a queue management module and an interrupt module,
and wherein the inter-core communication method for the multi-core processor comprises:
receiving, by the memory management module, a descriptor application instruction sent by a first system, and determining, by the memory management module, a descriptor pointer corresponding to the descriptor application instruction, wherein the first system is configured to store data to be transmitted into memory corresponding to the descriptor pointer;
after receiving an enqueue application sent by the first system, enqueuing, by the queue management module, the descriptor pointer into a specified queue; and
after the number of times of enqueues corresponding to the specified queue reaches a preset threshold, dequeuing, by the interrupt module, the descriptor pointer in the specified queue through an interrupt service program of a second system, wherein the second system is configured to read data to be transmitted in a memory corresponding to the dequeued descriptor pointer.

9-10. (canceled)

11. The inter-core communication system for the multi-core processor according to claim 4, wherein the queue controller is configured to read the descriptor pointer in the off-chip memory after the descriptor pointer in the on-chip memory is less than a preset number.

12. The inter-core communication method for the multi-core processor according to claim 8, wherein the memory management module comprises a first bus interface, a first register, a buffer and an on-chip memory, and the memory management module is connected to each of the systems through the first bus interface, and wherein determining, by the memory management module, the descriptor pointer corresponding to the descriptor application instruction comprises:
determining, by the first register, the descriptor pointer corresponding to the descriptor application instruction after receiving the descriptor pointer application instruction sent by the first system, and storing, by the first register, the descriptor pointer into the on-chip memory.

13. The inter-core communication method for the multi-core processor according to claim 12, wherein the first register comprises a control register, a descriptor application register, a descriptor release register and a statistics register, the descriptor application register being configured to provide an application interface for a descriptor pointer to the first system, the descriptor release register being configured to provide a release interface of a descriptor pointer to the first system, the statistics register being configured to count the number of times of operations on the descriptor pointer, and wherein determining, by the first register, the descriptor pointer corresponding to the descriptor application instruction after receiving the descriptor pointer application instruction sent by the first system, and storing, by the first register, the descriptor pointer into the on-chip memory comprises:
determining, by the control register, the descriptor pointer corresponding to the descriptor application instruction after receiving the descriptor pointer application instruction sent by the first system, and storing, by the control register, the descriptor pointer into the on-chip memory.

14. The inter-core communication method for the multi-core processor according to claim 8, wherein the inter-core communication device further comprises an arbitration module connected to the memory management module and the queue management module, and wherein the inter-core communication method for the multi-core processor further comprises:
performing, by the arbitration module, access arbitration on access of each system according to a preset communication sequence when multiple systems are detected to access the inter-core communication device simultaneously, and responding, by the arbitration module, to the access of each system in turn.

15. The inter-core communication method for the multi-core processor according to claim 8, further comprising:
performing, by the interrupt module, an exception interrupt after an exception occurs in the memory management module, and performing, by the interrupt module, an exception interrupt after an exception occurs in the queue management module.

16. A multi-core processor, comprising an inter-core communication device and a plurality of systems connected to the inter-core communication device, wherein the plurality of systems comprise a first system and a second system, and the inter-core communication device comprises:
a memory management module configured to receive a descriptor application instruction sent by the first system and determine a descriptor pointer corresponding to the descriptor application instruction, wherein the first system is configured to store data to be transmitted in a memory corresponding to the descriptor pointer;
a queue management module configured to enqueue the descriptor pointer to a specified queue after receiving an enqueue application sent by the first system; and
an interrupt module configured to dequeue the descriptor pointer in the specified queue through an interrupt service program of the second system after the number of times of enqueues corresponding to the specified queue reaches a preset threshold, wherein the second system is configured to read data to be transmitted in a memory corresponding to the dequeued descriptor pointer.
